(19) United States
(12) Patent Application Publication
(10) Pub. No.: US 2013/0001094 A1
(43) Pub. Date: Jan. 3, 2013

(54) Lanthanide-Mediated Water Splitting Process for Hydrogen and Oxygen Generation

(75) Inventors: Robert Cable, Las Vegas, NV (US); Anthony J. Perrotta, Boalsburg, PA (US); Carl Hassler, Gig Harbor, WA (US); John Burba, Parker, CO (US)

(73) Assignee: MOLYCORP MINERALS, LLC, Greenwood Village, CO (US)

(21) Appl. No.: 13/465,937

(22) Filed: May 7, 2012

Related U.S. Application Data
(60) Provisional application No. 61/483,570, filed on May 6, 2011.
(60) Provisional application No. 61/484,137, filed on May 9, 2011.

(51) Int. Cl. C25B 1/04; C25B 9/00; C25B 11/04; C25B 15/08; B82Y 30/00

(52) U.S. Cl. 205/340; 205/628; 205/631; 204/234; 204/242; 977/734; 977/742; 977/932

(57) ABSTRACT

The application generally relates to a process for generating hydrogen, oxygen or both from water. More particularly, the application generally relates to a lanthanide-mediated electrochemical and/or photoelectrochemical process for generating hydrogen, oxygen or both from water.

### CROSS REFERENCE TO RELATED APPLICATIONS

The present application claims the benefits of U.S. Provisional Application Ser. Nos. 61/483,570 filed May 6, 2011, and 61/484,137, filed May 9, 2011, all entitled “Lanthanide-Mediated Photochemical-Catalytic Water Splitting Process for Hydrogen Generation, the entire contents of each is incorporated herein by this reference.

### FIELD OF INVENTION

This disclosure relates generally to a process for generating from water one or both of hydrogen and oxygen, more particularly to a lanthanide-mediated electrochemical process for generating hydrogen, oxygen or both from water.

### BACKGROUND OF THE INVENTION

Numerous processes exist for producing hydrogen and oxygen from water. For example, hydrogen is industrially produced from water by many processes.

The most widely practiced industrial process for producing hydrogen is steam reformation of organic compounds. However, steam reformation from a hydrocarbon feed stream produces large volumes of carbon dioxide as a by-product. As such, steam reformation is an unfavorable industrial process for hydrogen production.

Electrolysis of water to generate hydrogen is another industrial process. While producing neither carbon dioxide nor requiring a hydrocarbon feed stream, the electrolysis of water requires a substantially large amount of electrical energy to generate hydrogen. The large amounts of electrical energy can be expensive and can have a large environmental overhead.

Yet another process for producing hydrogen is a thermochemical process. The thermochemical process produces hydrogen from a solid phase, gaseous phase or supercritical fluid phase reaction. Solar energy can be used as the thermal energy source. However, the thermochemical reactions typically require temperatures exceeding 500 degrees Celsius, and even more typically exceeding 1000 degrees Celsius. Furthermore, many of the thermochemical processes include highly corrosive reactants and/or products. The solid phase thermochemical reactions may be further complicated by a need to preserve nano-crystalline states throughout the reaction or with a need to dissolve a solid phase formed during the reaction. Moreover, thermochemical processes can include multiple phase separation or purification stages. Many thermochemical processes' reactive interfaces can be impaired by passivation of the interface.

A photo-catalytic process can produce hydrogen, oxygen or both from water. Oxygen is produced by a photo-catalytic oxidation of water, and hydrogen is produced by photo-catalytic reduction of water. The oxidation and reduction processes can involve homogenous and/or heterogeneous catalysis. The catalytic systems, while exhibiting good activities, often require expensive reagents, complex nano-structured solids, and/or sacrificial oxidants or reductants other than water.

A need exists for generating one or both of hydrogen and oxygen from water that is substantially free of expensive sacrificial reagents, high temperatures and/or pressures, and/or large electrical overpotentials.

### SUMMARY OF THE INVENTION

These and other needs are addressed herein by various embodiments and configurations. This disclosure generally relates to the generation of hydrogen and, more specifically to the generation of one or both of hydrogen and oxygen from water.

In an embodiment, a process and device are provided that perform the following steps/operations:

(a) forming, in a cathodic compartment, hydrogen gas, wherein the cathodic compartment contains a cathode;

(b) forming, in a catalyst compartment, oxygen gas by a one or more chemical reactions involving a catalyst; and

(c) forming, in an anodic compartment, an electric current, wherein the anodic compartment contains an anode electrically interconnected with the cathode, wherein the anodic and cathodic compartments are in fluid communication and the catalyst compartment is in fluid communication with one or both of the anodic and cathodic compartments.

In an embodiment, a process and device are provided that perform the following steps/operations:

(a) forming, in a catalyst compartment, oxygen gas by catalytic reduction of cerium (+4) to cerium (+3);

(b) forming an electric current, in an anodic compartment containing an anode, by oxidizing cerium (+3) to cerium (+4);

(c) forming, in a cathodic compartment containing a cathode, hydrogen gas; and

(d) passing the cerium (+4) formed in the anodic compartment to the catalyst compartment and the cerium (+3) formed in the catalyst compartment to the anodic compartment wherein the anode and cathode are electrically interconnected.

In an embodiment, an electrochemical device is provided that includes:

(a) a anodic compartment having an anode;

(b) a cathodic compartment having a cathode; and

(c) a catalyst compartment containing a catalyst.

The anodic and cathodic compartments are in fluid communication, and the catalyst compartment is in fluid communication with one or both of the anodic and cathodic compartments. The anode and cathode are electrically interconnected.

Various device configurations can be employed including, without limitation, the following:

i) the catalyst compartment is in fluid communication with the anodic compartment;

ii) the catalyst compartment is in fluid communication with the cathodic compartment; and

iii) the catalyst compartment is in fluid communication with both the anodic and cathodic compartments.

The catalyst can be a variety of materials. An example is platinum (such as one or both of nano crystalline platinum, high surface area platinum, or a combination thereof). In a particular configuration, the catalyst comprises from about 1 to about 90 wt % of platinum or from about 2 to about 25 wt % of platinum. The catalyst commonly has a surface area of from about 0.001 m²/g to about 1,000 m²/g and more commonly from about 30 m²/g to about 50 m²/g. In another configuration, the catalyst comprises about 10 wt % of platinum. The catalyst material can be supported or unsupported. Suitable supports include activated carbon, carbon black, graphite, graphene, carbon nanotubes, and high surface area amorphous carbon, a metal oxide other than the catalytic material (e.g., ZrO, aluminum oxide, a rare earth oxide, and the like), SiO₂, and zeolites.

The catalytic zone can be configured in a number of ways. In one configuration, the catalyst is in the form of a catalyst bed, such as a porous and permeable catalyst bed. The porous catalyst is one of a macro-porous catalyst, micro-porous catalyst, and a mixture thereof.

In one configuration, the cathode comprises platinized platinum.

In one configuration, the anode is a photoanode that is photoactivated by one or more of sun light, visible-light, and ultraviolet light. The light can, before contacting with the anode, be one or both of concentrated by one or more lenses and channeled by one or more optical fibers. The photoanode is commonly a semi-conductor and more commonly one or more of tungstic oxide (WO₃), titanium dioxide (TiO₂), titanium oxide (TiO), indium antimonide (InSb), lead (II) selenide (PbSe), lead (II) telluride (PbTe), indium (III) arsenide (InAs), lead (II) sulfide (PbS), germanium (Ge), gallium antimonide (GaSb), indium (III) nitride (InN), iron disillicide (FeSi₂), silicon (Si), copper (II) oxide (CuO), indium (III) phosphide (InP), gallium (III) arsenide (GaAs), cadmium telluride (CdTe), selenium (Se), copper (I) oxide (Cu₂O), aluminum arsenide (AlAs), zinc telluride (ZnTe), gallium (III) phosphide (GaP), cadmium sulfide (CdS), aluminum phosphide (AlP), zinc selenide (ZnSe), silicon carbide (SiC), zinc oxide (ZnO), titanium (IV) oxide (TiO₂), gallium (III) nitride (GaN), zinc sulfide (ZnS), ITO or indium tin oxide (In₂O₃)_{0.9}(SnO₂)_{0.1}, diamond (C), aluminum nitride (AlN) and mixtures and composites thereof.

In one application, the photoanode has a bandgap of at least about 1.2 eV whereby when the photoanode is irradiated with electromagnetic energy, the device generates sufficient electrochemical potential to carry out an electrolysis process with little, if any, electrical power from an applied power source.

In one application, the photoanode has a bandgap of less than about 1.2 eV, whereby when the photoanode is irradiated with electromagnetic energy, the device requires application of at least some additional electrical energy from the power source to carry out an electrochemical process.

The electric current produced by the device can be formed by one or both of chemical reaction and photoelectrochemical processes. In one configuration, the electric current further comprises oxidizing cerium (+3) to cerium (+4) and reducing, in the catalytic compartment, cerium (+4) to cerium (+3) in the anodic compartment to form oxygen gas. The process includes passing the formed cerium (+4) from the anodic compartment to the catalyst compartment. The formation of the oxygen gas and cerium (+3) can occur in the substantial absence of an applied electrical potential. In one configuration, the electric current further comprises oxidizing cerium (+3) to cerium (+4) and reducing, in the cathodic compartment, H⁺ or H₃O⁺ to form hydrogen gas.

The process and device can have a number of advantages. For example, the process and device can generate efficiently and inexpensively one or both of hydrogen and oxygen from water. The process and device can require only water and in some configurations water and light as inputs and be substantially free of expensive reagents, high temperatures and/or pressures, and/or large electrical overpotentials. The catalytic process and device can exhibit good activities, without the need for complex nano-structured solids and/or sacrificial oxidants or reductants other than water. The process and device can have a low environmental overhead and impact.

These and other advantages will be apparent from the disclosure contained herein.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “actinide series” refers to one or more of actinium, thorium, protactinium, uranium, neptunium, plutonium, americium, curium, berkelium, californium, einsteinium, fermium, mendelevium, nobelium and lawrencium.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

A “catalyst” refers to a substance that increases the rate of a chemical reaction, typically by reducing the activation energy. The catalyst is left substantially unchanged by the reaction.

The term “electrochemical” refers to the interaction or interconversion of chemical and electrical energies.

An “oxide” refers to a compound comprising an element or radical with oxygen.

The term “photoelectrochemical” refers to a process involving transforming, by a chemical process, light into another form of energy.

A “platinum group metal” refers to chemical elements of the second and third triads of Group VIII of the Mendeleev periodic system. The group includes the light metals ruthenium (Ru), rhodium (Rh), and palladium (Pd), and the heavy metals osmium (Os), iridium (Ir), and platinum (Pt).

A “rare earth” refers to one or more of yttrium, scandium, lanthanum, cerium, praseodymium, neodymium, samarium, europium, gadolinium, terbium, dysprosium, holmium erbium, thulium, ytterbium, and lutetium. As will be appreciated, lanthanum, cerium, praseodymium, neodymium, samarium, europium, gadolinium, terbium, dysprosium, holmium erbium, thulium, ytterbium, and lutetium are known as lanthanoids.

The preceding is a simplified summary of various embodiments to provide an understanding of some aspects of the disclosure. This summary is neither an extensive nor exhaustive overview of the embodiments. It is intended neither to identify key or critical elements nor to delineate the scope of the disclosure but to present selected concepts of the various embodiments in a simplified form as an introduction to the more detailed description presented below. As will be appreciated, other embodiments are possible utilizing them, alone or in combination, one or more of the features as set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how one or more embodiments disclosed herein can be made and used and are not to be construed as limiting the disclosure to only the illustrated and described examples.

Further features and advantages will become apparent from the following, more detailed, description of the various embodiments of the disclosure, as illustrated by the drawings referenced below.

FIG. 1 depicts the ultra-violet visible absorption spectrum for cerium (III) and cerium (IV) metal-solute species;

FIGS. 2A and 2B show a gas chromatography analysis of atmospheres above a 0.15 M Ce₂(SO₄)₃ in 0.35 N sulfuric acid solution before and after irradiation of the solution with an ultra-violet laser;

FIG. 3 is a representation of a reactor according to an experimental configuration;

FIGS. 4A and 4B are plots of molar concentration (%) of various gases versus time (min);

FIG. 5 is a chromatogram of ambient air;

FIGS. 6A-F are various device configurations according to embodiments of this disclosure;

FIG. 7 is a flow chart according to an embodiment; and

FIG. 8 is a plot of absorbance versus wavelength of eerie methanesulfonate in methanesulfonic acid and the catalytically reduced solution.

### DETAILED DESCRIPTION OF THE INVENTION

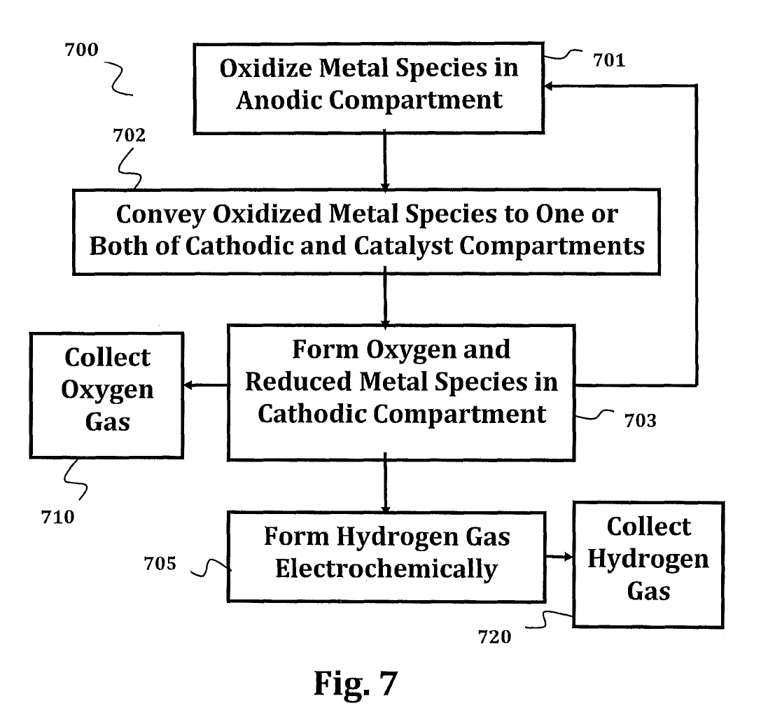

Some embodiments include an electrochemical process 700 for forming molecular hydrogen and oxygen gases (FIG. 7). The hydrogen gas is preferably formed in a cathodic compartment of an electrochemical cell and the oxygen gas is preferably formed in a catalyst compartment interconnected to the electrochemical cell.

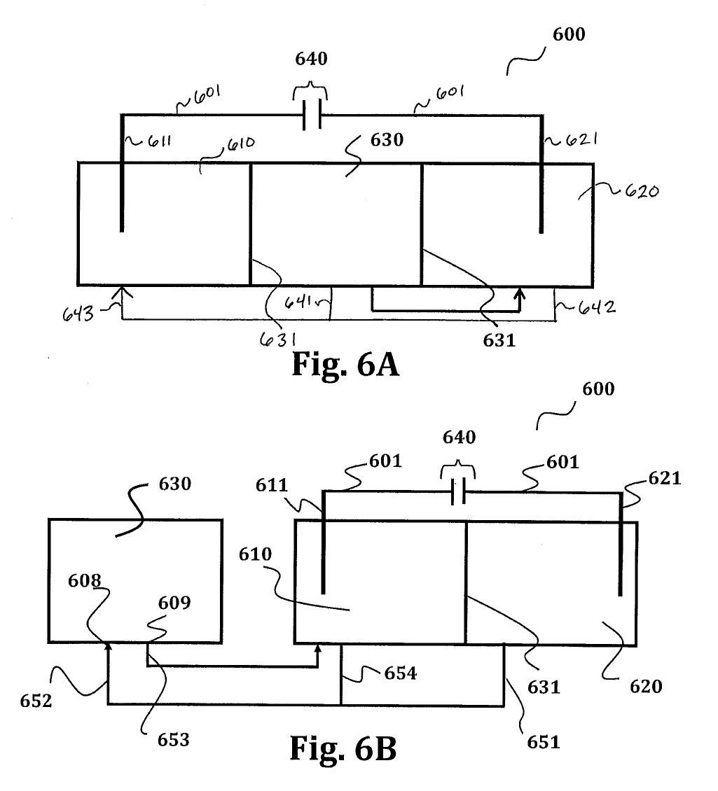

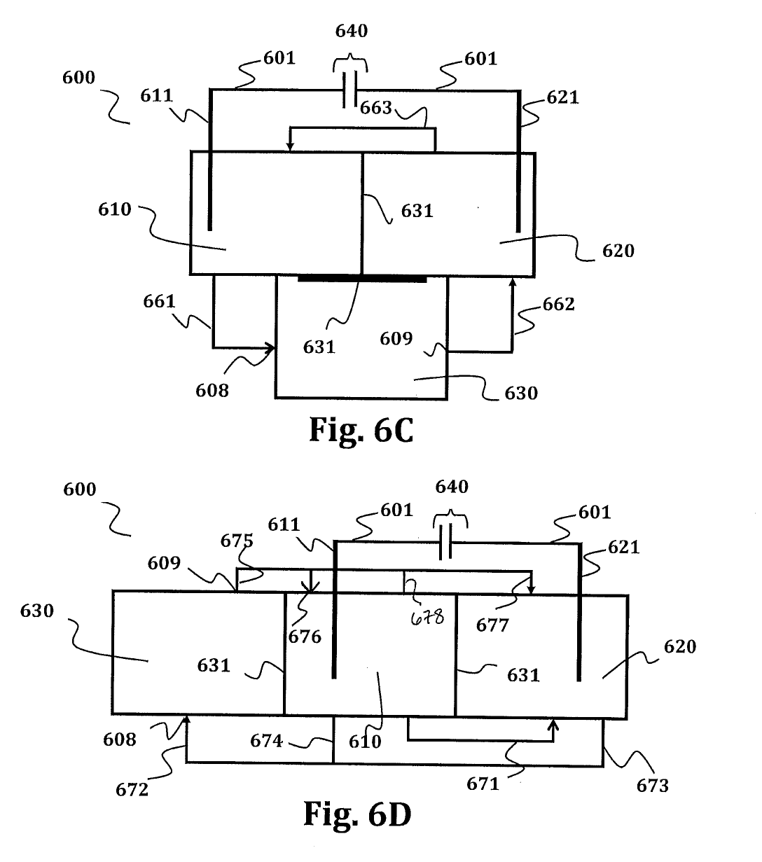

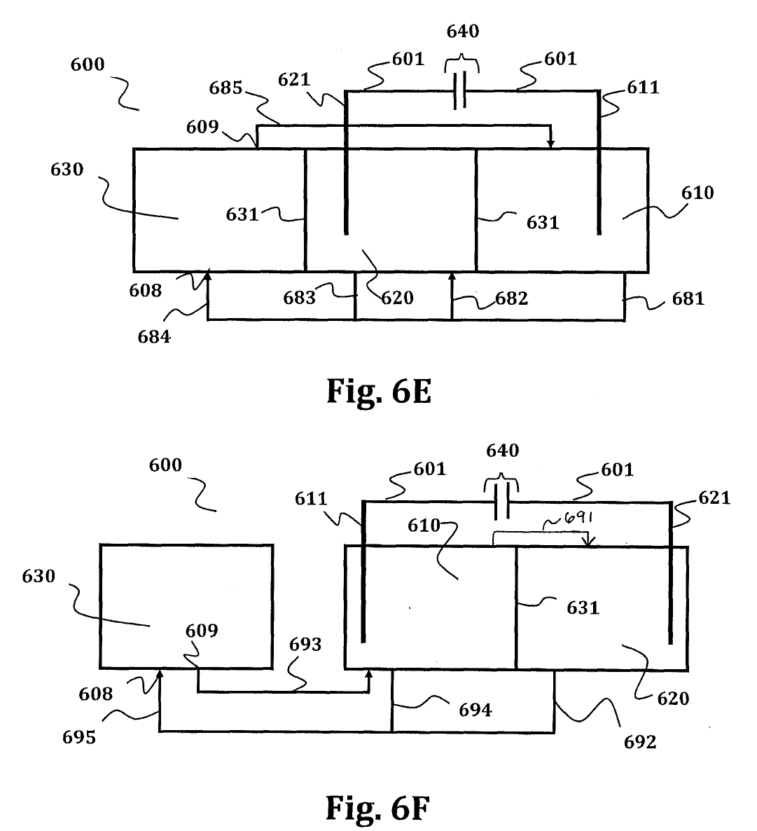

FIGS. 6A-6F depict non-limiting configurations of suitable electrochemical devices 600 according to some embodiments. The electrochemical process 700 is preferably conducted in electrochemical device 600. The electrochemical device 600 preferably comprises an anodic compartment 610, a cathodic compartment 620 and a catalyst compartment 630. A metal species-containing solution is contained in the anodic 610, cathodic 620 and catalytic 630 compartments. The catalyst compartment 630 is in fluid communication with one or both of the anodic 610 and cathodic 620 compartments.

The metal species mediates the formation of the molecular hydrogen and oxygen gases. The metal species is not consumed in the process of forming the molecular oxygen and hydrogen gases.

An anode 611 is typically positioned in the anodic compartment 610 and a cathode 621 is typically positioned in the cathodic compartment 620. The anode 611 and cathode 621 are electrically interconnected.

FIG. 6A depicts a configuration of the electrochemical device 600 having the catalyst compartment 630 position between the anodic 610 and cathodic compartment 620. The catalyst compartment 630 is in fluid communication with the anodic 610 and cathodic 620 compartments. Fluid communication between the anodic 610 and cathodic 620 compartments is through the catalyst compartment 630. The fluid is conveyed from the anodic compartment 610 to the catalyst compartment 630, effectively conveying the oxidized metal species to the catalyst compartment 630 so that it may be reduced with the concomitant oxidation of water to O₂ and H⁺. The fluid is then conveyed from the catalyst compartment 630 to the cathodic compartment 620, conveying H⁺ to the cathode 621 where it may be reduced to H₂. Porous barriers 631 may separate the catalyst compartment 630, respectively, from the andoic aid and cathedic 620 compartments.

FIG. 6B depicts a configuration of the electrochemical device 600 having the anodic compartment 610 separately and independently interconnected to the catalyst 630 and cathodic 620 compartments. The anodic 610 and catalyst 630 are in fluid communication and may or may not be separated by porous barrier 631. The cathodic 620 and anodic 610 compartments are in fluid communication. The fluid is conveyed from the anodic compartment 610 via conduit 652 to the catalyst compartment 630, effectively conveying the oxidized metal species to the catalyst compartment 630 so that it may be reduced with the concomitant oxidation of water to O₂ and H⁺. The fluid is then conveyed from the catalyst compartment 630 via conduit 653 to the cathodic compartment 620, conveying H⁺ to the cathode where it may be reduced to H₂.

FIG. 6C depicts a configuration of the electrochemical device 600 having the anodic 610 and cathodic 620 compartments interconnected with one another and with the catalyst compartment 630. The anodic 610 and cathodic 620 compartments are in fluid communication and may or may not be separated by porous barrier 631. The catalyst compartment 630 is in fluid communication with the anodic 610 and cathode 620 compartments. Fluid communication between the anodic 610 and cathodic 620 compartments may be directly between compartments or through the catalyst compartment 630. The catalyst compartment 630 may or may not be separated by one or both of the anodic 610 and cathodic 620 compartments by porous barrier 631.

FIG. 6D depicts a configuration of the electrochemical device 600 having the anodic compartment 610 positioned between the catalyst 630 and cathodic 620 compartments. The anodic compartment 610 is in fluid communication with the cathodic 620 and catalyst 630 compartments. However, any fluid communication between the cathodic 620 and catalyst 630 compartments is through the anodic compartment 610. In accordance with the configuration depicted in FIG. 6D the anodic 610 and cathodic 620 compartments may or may not be separated by porous barrier 631.

FIG. 6E depicts a configuration of the electrochemical device 600 having the cathodic compartment 620 positioned between the anodic 610 and catalyst 630 compartments. The cathodic compartment 620 is in fluid communication with the anodic 610 and catalyst 630 compartments. In accordance with the configuration depicted in FIG. 6E the anodic 610 and cathodic 620 compartments may or may not be separated by porous barrier 631.

FIG. 6F depicts a configuration of the electrochemical device 600 having the anodic 610 and cathodic 620 compartments interconnected with one another and with the catalyst compartment 630. The anodic 610 and cathodic 620 compartments are in fluid communication and may or may not be separated by porous barrier 631. The catalyst compartment 630 is in fluid communication with the anodic 610 and cathode 620 compartments. Fluid is withdrawn from the cathodic compartment 620 and conveyed to the catalyst compartment 630. The fluid is conveyed from the anodic compartment 610 to the catalyst compartment 630, effectively conveying the oxidized metal species to the catalyst compartment 630 so that it may be reduced with the concomitant oxidation of water to O₂ and H⁺. The fluid is then conveyed from a catalyst compartment 630 to the cathodic compartment 620, conveying H⁺ to the cathode where it may be reduced to H₂.

Preferably, the fluid communication between the anodic 610 and cathodic 620 compartments substantially supports electrolyte flow to support current flow between the anodic 610 and cathodic 620 compartments. For example, the electrolyte flow between the anodic 610 and cathodic 620 compartments supports cationic flow from the anodic compartment 610 to cathodic compartment 620 and anionic flow to the anodic compartment 610 from the cathodic compartment 620.

The anode 611 is preferably at least partially, if not mostly, immersed in an anolyte solution (not depicted in FIGS. 6A-6F). The anode 611 may comprise one of lead oxide (PbO); lead dioxide (PbO₂); cerium (IV) oxide; tungsten; transparent conducting metal oxides such as indium tin oxide, fluorine doped tin oxide, and doped zinc oxide; graphite; activated carbon; carbon nanotubes; platinum; gold; silver; steel; cobalt; and cobalt alloys; transparent conducting polymers such as poly(3,4-ethylenedioxythiophene), poly(3,4-ethylenedioxythiophene), and poly(4,4-dioctylcyclopentadithiophene). In accordance with some embodiments, the anode 611 comprises tungsten, preferably one or more of tungsten oxide; tungsten (IV) oxide (WO₂), tungsten (VI) oxide (WO₃), ditungsten pentaoxide (W₂O₅), and tetratungsten undecaoxiede (W₄O₁₁). Tungsten oxide (WO₃) is also commonly referred to as tungsten trioxide, tungsten (VI) trioxide and tungstic anhydride (WO₃). The surface area of the anode 611 can have a substantial impact on current density. Commonly, the surface area of the anode 611 is at least about 0.001, more commonly at least about 1,000, and even more commonly at least about 5,000 m²″g. Common current densities for the electrochemical device 600 are at least about 500 A/m², more commonly at least about 1,000 A/m², more commonly at least about 1,500 A/m², more commonly at least about 2,000 A/m², more commonly at least about 2,500 A/m², and even more commonly at least about 3,000 A/m².

The anolyte solution preferably comprises an aqueous solution containing the metal species. The metal species is in the form of a substantially dissolved metal species-containing solution.

The cathode 621 is preferably partially, if not mostly, immersed in a catholyte solution (not depicted in FIGS. 6A-6F). The cathode may comprise one of graphite, activated carbon, carbon nanotubes, platinum, gold, silver, steel, and lead dioxide.

The catholyte solution preferably comprises an aqueous solution containing the metal species. The metal species is in the form a substantially dissolved metal species-containing solution.

A conductor 601 electrically interconnects the anode 611 and cathode 621. In some configurations, the conductor 601 electrically interconnects an electrical power source 640 with the anode 611 and cathode 621. The electrical power source 640 is preferably a direct current power source. The direct current power source 640 preferably provides an electrical potential of at least about 1 volt, more preferably at least about 1.5 volts. The direct current power source 640 preferably provides the current density referenced previously. The electrical power source 640 may comprise one of an electrochemical battery, a photovoltaic cell, a rectifier, a capacitor, fuel cell, or turbine.

In step 701 of the electrochemical process 700 depicted in FIG. 7, a metal species is oxidized in the anodic compartment 610. More specifically, in the anodic compartment 610, a reduced-form of the metal species (also referred to herein as the reduced metal species) is electrochemically oxidized to an oxidized-form of the metal species (also referred to herein as the oxidized metal species). While not wanting to be limited by theory, it is believed that the reduced metal species forms the oxidized metal species by donating and/or releasing one or more electrons to the anode 611. The electrons donated and/or released to the anode 611, flow from the anode 611 to the cathode 621 through electrical conductor 601.

An electric current is formed by the electrochemical oxidation process in the anodic compartment 610. As will be appreciated, the electric potential between the electrodes is the driving force for the electrochemical oxidation of the reduced metal species. The electric potential is commonly from about 0.01 to about 3.0 volts versus SHE (standard hydrogen electrode). Preferably, the electric potential is from about 0.2 to about 2 volts versus SHE, more preferably from about 0.5 to about 1.5 volts versus SHE. Typically, the current is expressed in terms of current density, such as amps or milliamps per square centimeter. The electric current density can vary. Typical current densities are from about 0.1 A/cm² to about 10 A/cm², more typically preferably from about 1 A/cm² to about 7 A/cm²

The metal species has at least two oxidation states, preferably a reduced (lower oxidation) state and an oxidized (higher oxidization) state. Preferably, the metal species has an oxidation potential of at least about 1.1 volts versus the standard hydrogen electrode (SHE).

The metal species is preferably a member of one of the IB, IVA and IIIB groups of the periodic table. The IIIB group comprises the lanthanide and actinide series of elements. As used herein, the lanthanide series refers to a “rare earth”. More preferably, the metal species is one of gold, cerium, praseodymium, europium, berkelium, curium, and lead. Even more preferably, the metal species is one of gold, lead, cerium, europium, and praseodymium. Yet even more preferably the metal species is one of cerium and lead. In some configurations, the metal species is cerium.

In accordance with some embodiments, the oxidized metal species comprise one or more of Au³⁺, Pb⁴⁺, Pb²⁺, Ce⁴⁺, Eu³⁺, Pr⁴⁺, Bk⁴⁺, and Cm⁴⁺. Preferably, the oxidized metal species comprise one of Au³⁺, Pb⁴⁺, Pb²⁺, Ce⁴⁺, Eu³⁺, and Pr⁴⁺. More preferably, the oxidized metal species comprises Ce⁴⁺.

In accordance with some embodiments, the reduced metal species comprise one or more of Au⁺, Pb²⁺, Pb⁰, Ce³⁺, Eu²⁺, Pr³⁺, Bk³⁺ and Cm³⁺. Preferably, the reduced metal species comprise one of Au⁺, Pb²⁺, Pb⁰, Ce³⁺, Eu²⁺, and Pr³⁺. More preferably, the oxidized metal species comprises Ce³⁺.

In some configurations, the reduced metal species comprises cerium (+3) and oxidized metal species comprises cerium (+4). In accordance to some configurations, cerium (+3) is oxidized to cerium (+4) in anodic compartment 610 as part of an electrochemical process. While not wanting to limited by theory, it is believed that the cerium (+3) forms cerium (+4) by donating and/or releasing an electron to anode 611. In some configurations, the oxidation of cerium (+3) to cerium (+4) can consume at least some, if not most, of the current provided by the electrical power source 640. As will be appreciated, when there is no other electrochemical or photoelectrochemical processes occurring other than the oxidation of Ce(III) to Ce(IV), then the oxidation of Ce(III) should theoretically generate all of the current.

In some configurations, the metal species may comprise a hydrated metal species, an acidic metal species, or a combination and/or mixture of both. Stated another way, the anolyte solution may comprise a hydrated metal species, an acidic metal species, or a combination and/or mixture of both and the catholyte solution may comprise a hydrated metal species, an acidic metal species, or a combination and/or mixture of both.

Preferably, the metal species comprises one or both of cerium sulfate and cerium methanesulfonate. Preferably, the reduced metal species comprises one or both of cerium (III) sulfate and cerium (III) methanesulfonate, and the oxidized metal species comprises one or both of cerium (IV) sulfate and cerium (IV) methanesulfonate.

In some configurations, the metal species may include ligands. The ligands may chemically interact with the metal species to increase one or both of the solution concentration of the metal species and the chemical reactivity of metal species. Non-limiting examples of suitable ligands are water, sulfuric acid, methane sulfonic acid, sulfonates, phosphonates, chelating-agents (or sequestering-agents) and mixtures thereof. The sulfonate can be any RSO₂O⁻, (that is, R—(S═O)₂O⁻), where R is an organic radical. Preferably, the sulfonate is one or more of methanesulfonate, trifluoromethanesulfonate, p-toluenesulfonate, benzenesulfonate, or a mixture thereof. The organophosphonic acids can be any R—P(═O)(OH)₂, (or, R-(P═O)O₂⁻ anions), where R is an organic radical. Preferably, the organophosphonic acid is one of methyl, ethyl, propyl, isopropyl, ethylenediamine(tetramethylene), hexamethylenediamine(tetramethylene), hexamethylenediamine(tetramethylene), or ethlenediamine(pentamethylene) phosphonic acid or a mixture thereof. Furthermore, the chelating-agent can be bi-, tri-, tetra-, penta- or hexa-valent agents. By way of example, the chelating-agent can be ethylenediamine, ethylenediamainetriacetic acid (or acetate), triethylenetetramine, diethylenetriamine, ethylenediaminetetraacetic acid (or acetate), tris(2-aminoethyl)amine, 1,4,7,10-tetraazacyclododecane-1,4,7,10-tetraacetate, diethylenetriaminepentaacetate, 1,4,7-triazacyclonane, 1,4,7-trithiacyclonane, and mixtures thereof.

The oxidization process in the anodic compartment 610 is preferably conducted in an anolyte solution comprising an acid. The acid may comprise any acid. Preferably, the acid maintains the reduced and oxidized metal species in solution. Preferably, the acid comprises sulfuric acid (H₂SO₄), methane sulfonic acid (CH₃SO₃H), or mixture thereof.

The anolyte solution may be a strongly acidic solution or weakly acidic solution. The anolyte solution may have pH value of less than about pH 0, less than about pH 1, less than about pH 2, less than about pH 3, less than about pH 4, less than about pH 5, less than about pH 6, or less than about pH 7. In some configurations, the anolyte solution may have a pH value of about pH 7 or more.

In accordance with some embodiments, step 701 may optionally include contacting electromagnetic energy 612 with the anode 611. In such instance, the anode 611 may comprise a photo-anode and/or a photo-catalytic anode. Preferably, anode 611 is photo-activated when contacted with electromagnetic energy 612. While not wanting to be limited by any theory, the photo-activation of anode 611 may one or more of generate electrons and/or holes, assist in the donation and/or release one or more electrons during the oxidation/reduction of the metal species, assist in the creation and/or destruction of holes, or a combination thereof. In other applications, the anode 611 is irradiated with electromagnetic energy having a wavelength that creates electrons and holes in the photoanode and another wavelength that excites the reduced metal species, allowing it to be oxidized more easily.

The contacting of the electromagnetic energy 612 with the anode 611 forms a photo-potential and photocurrent. The photo-potential is commonly from about 0.01 to about 3.0 volts versus SHE (standard hydrogen electrode). Preferably, the photo-potential is from about 0.2 to about 2 volts versus SHE, more preferably from about 0.5 to about 1.5 volts versus SHE. Typically, the photocurrent is expressed in terms of photocurrent density, such as amps or milliamps per square centimeters of anode 611. The photocurrent density can vary. Typical photocurrent densities are from about 0.01 mA/cm² to about 100 mA/cm², preferably from about 0.05 mA/cm² to about 50 mA/cm². In some configurations, the photo-potentials and photocurrents are sufficient that the electrochemical process 700 proceeds without an electrical power source 640.

The electromagnetic energy 612 commonly comprises electromagnetic wavelengths from about 100 nm to about 5,000 nm, more commonly electromagnetic wavelengths from about 280 nm to about 3,000 nm, even more commonly electromagnetic wavelengths from about 300 nm to about 1,500 nm, or yet even more commonly electromagnetic wavelengths from about 390 nm to about 750 nm. In some configurations, the electromagnetic energy 612 comprises electromagnetic wavelengths from about 100 nm to about 1,000 nm.

The electromagnetic energy 612 can be derived from any suitable electromagnetic energy source. Preferably, the electromagnetic energy source is one or more of a lamp, laser, light-emitting diode, or solar source. The laser preferably provides electromagnetic energy of a suitable wavelength as indicated above. The laser may be one of a gas, chemical, excimer, solid-state, fiber, photonic, semi-conductor, dye or free-electron laser operate in one of continuous or pulsed form. In some embodiments, the laser commonly has an average power of at least about 1 watt, more commonly at least about 10 watts, even more commonly has an average power at least about 100 watts, yet even more commonly has an average power at least about 250 watts, still yet even more commonly has an average power at least about 500 watts, still yet even more commonly has an average power at least about 1,000 watts, still yet even more commonly has an average power at least about 2,000 watts, still yet even more commonly has an average power at least about 4,000 watts, still yet even more commonly has an average power at least about 6,000 watts, still yet even more commonly has an average power at least about 8,000 watts, still yet even more commonly has an average power at least about 10,000 watts, still yet even more commonly has an average power at least about 20,000 watts, still yet even more commonly has an average power at least about 50,000 watts, or still yet even more commonly has an average power at least about 90,000 watts. In other embodiments, the laser commonly has a peak power of at least about 10³ watts, more commonly at least has a peak power of about 10⁴ watts, even more commonly has a peak power of at least about 10⁵ watts, yet even more commonly has a peak power of at least about 10⁶ watts, still yet even more commonly has a peak power of at least about 10⁷ watts, still yet even more commonly has a peak power of at least about 10⁸ watts, still yet even more commonly at has a peak power of least about 10⁹ watts, still yet even more commonly has a peak power of at least about 10¹⁰ watts, still yet even more commonly has a peak power of at least about 10¹¹ watts, or still yet even more commonly at least about 10¹² watts. Non-limiting examples of suitable lamps include arc, incandescent and discharge lamps. Preferably, the lamp is a discharge lamp. More preferably, the lamp is one of a plasma, induction, low-pressure, high-pressure, noble gas discharge, sodium vapor discharge, mercury vapor discharge, metal-halide vapor discharge, xenon vapor discharge, or combination thereof. In some embodiments, the electromagnetic energy 612 comprises sunlight. The sunlight may include focused sunlight, filtered sunlight or a combination of filtered and focused sunlight.

In some embodiments, the electromagnetic energy 612 may be applied continuously, may be applied intermediately, or may be applied continuously in an intermediate manner (such as, continuously applied in a pulsed manner) during the reduction process. The pulsed manner can have a regulated pattern (such as, a substantially regular, repeating pattern or frequency) or can have an unregulated pattern (such as, a substantially irregular, non-repeating pattern or frequency).

It can be appreciated that when step 701 includes electromagnetic energy 612, the process is conducted in an anodic compartment 610 having at least some transmittance to the electromagnetic energy 612. The anodic compartment 610 may have an aperture and/or at least a portion of the anodic compartment 610 that transmits the electromagnetic energy 612. The anodic compartment 610, aperture or at least portion of the anodic compartment 610 having at least some transmittance to the electromagnetic energy 612. The anodic compartment 610 transmits least about most, at least about 90%, at least about 95%, at least about 99%, or at least about 99.5% of the electromagnetic energy 612.

In some embodiments, the anodic compartment 610 further includes one or more reflective surfaces. The reflective surfaces substantially reflect the electromagnetic energy 612 throughout the anolyte solution to increase the absorption of electromagnetic energy 612.

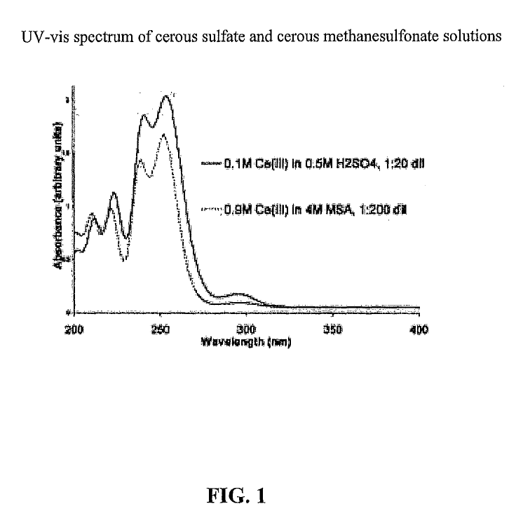

In some configurations, the electromagnetic energy 612 preferably corresponds with the ultra-violet visible absorption spectrum of one or both of cerium (III) and cerium (IV) as depicted in FIG. 1. The ultra-violet visible region of the electromagnetic spectrum generally corresponds to electromagnetic energies from about 25 nm to about 1,000 nm. More preferably, the electromagnetic energy has a wavelength from about 200 nm to about 325 nm, has a wavelength from about 200 nm to about 275 nm, has a wavelength from about 225 nm to about 275 nm, has a wavelength from about 235 nm to about 265 nm, has a wavelength from about 240 nm to about 360 nm, or has a wavelength of about 250 nm.

In some configurations, the electromagnetic energy 612 corresponds to the bandwidth of the photo-catalytic anode 611. The anode 611 can comprise any electrode activated by electromagnetic energy 612 having wavelengths from about 100 nm to about 1 mm, preferably from about 300 nm to about 1,500 nm. Preferably, the anode 611 comprises WO₃.

In step 702, the oxidized metal species is preferably conveyed from the anodic compartment 610 to one or both of the cathodic 620 and catalyst 630 compartments. The oxidized metal species may be conveyed from the anodic compartment 610 to the cathodic compartment 620 by one of diffusion (such as by electrochemical or electric potential gradient and/or concentration gradient) and/or a non-diffusion motive force (including without limitation positive or negative pressure, gravitational flow, and the like or combination thereof. Furthermore, the oxidized metal species may be conveyed from the anodic compartment 610 to the catalyst compartment 630 by one or more of diffusion (such as by electrochemical or electric potential gradient and/or concentration gradient) and/or a non-diffusion motive force (including without limitation positive or negative pressure, gravitational flow, and the like or combination thereof.

While not wanting to limited by theory, in the configuration depicted in FIG. 6A, the oxidized metal species is believed to conveyed to the catalyst compartment 630 substantially by diffusion due to the positive current flow from the anodic compartment 610 through the catalyst compartment 630 to cathodic 620 compartment. As noted previously diffusion may result from electrochemical or electric potential gradient and/or concentration gradient. Other conveyance techniques include without limitation a non-diffusion motive force including without limitation positive or negative pressure, gravitational flow, and the like.

It can be appreciated that for the configurations depicted in FIGS. 6A-6F at least some, if not most, of the positive current flow from the anode 611 to cathode 621 is believed to be supported by protons. This is believed to be due to at least in part to their high mobility in aqueous solutions, particularly acidic aqueous solutions. However, this does not imply that the oxidized and reduced forms of the metal species do not comprise at least some of the positive current flow between from the anode 611 to cathode 621.

In the configuration depicted in FIG. 6B, the oxidized metal species may be conveyed from the anodic compartment 610 by diffusion due to the positive current flow from the anodic 610 to cathodic 620 compartment due to the electrochemical potential between anode 611 and cathode 621. Preferably, the oxidized metal species is conveyed from the anodic compartment 610 and/or cathodic compartment 620 to the catalysis compartment 630 by lines 654, 657, and 652 (such as, but not limited to by pumping).

In the configuration depicted in FIG. 6C, the oxidized metal species is preferably conveyed by diffusion due to positive current flow from the anodic 610 to cathodic 620 compartment due to the electrochemical potential difference between anode 611 and cathode 621. The oxidized metal species may be conveyed one or both of directly from the anodic 610 to the cathodic 620 compartment and indirectly through the catalyst compartment 630, which is in fluid communication with both the anodic 610 and cathodic 620 compartments. In some configurations, the oxidized metal species may be conveyed by line 661 (such as, but not limited to pumping) from the anodic compartment 610 to the catalyst compartment 630 and from the catalyst compartment 630 to the cathodic compartment 620 through line 662 (such as, but not limited to pumping).

In the configuration depicted in FIG. 6D, the oxidized metal species is preferably conveyed by diffusion due to positive current flow from the anodic 610 to cathodic 620 compartment due to the electrochemical potential difference between anode 611 and cathode 621. The oxidized metal species may be conveyed from the anodic compartment 610 to the cathodic compartment 620 by line 671.

In the configuration depicted in FIG. 6E, the oxidized metal species is preferably conveyed by diffusion due to positive current flow from the anodic 610 to cathodic 620 compartments due to the electrochemical potential difference between anode 611 and cathode 621. Furthermore, in some configurations the oxidized metal species may be conveyed through line 681 (such as, but not limited to pumping) to one or both of the cathodic compartment 620 through line 682 and the catalysis compartment through line 684.

In the configuration depicted in FIG. 6F, the oxidized metal species is preferably conveyed by diffusion due to positive current flow from the anodic 610 to cathodic 620 compartment due to the electrochemical potential difference between anode 611 and cathode 621. Furthermore, in some configurations the oxidized metal species may be conveyed from the anodic compartment 610 to the cathodic compartment 620 through line 691 (such as, but not limited to pumping).

In some of the configurations depicted in FIGS. 6A-6F the anodic 610 and cathodic 620 compartments may or may not be separated by a porous barrier 631. Furthermore, in some configurations (such as, FIGS. 6A, 6C, 6D and 6E) the catalysis compartment 630 may or may not be preferably separated by porous barrier 631 from one or both of the anodic 610 and cathodic 620 compartments.

The porous barrier 631 is preferably at least a portion of a common wall separating one of the anodic 610, cathodic 620 and catalyst 630 compartments from one or more of the other of the anodic 610, cathodic 620 and catalyst 630 compartments. The porous barrier 631 may be one of a macro-porous barrier, a micro-porous barrier or combination thereof. Non-limiting examples of suitable porous barrier 631 materials are macro-porous glasses, micro-porous glasses, porous polymeric materials, and permeable membranes

In some configurations, the porous barrier 631 is a proton-conveying barrier that is substantially porous to protons and is substantially non-porous to species other than the protons. The proton-conveying barrier may comprise a proton exchange membrane, non-porous, hydrogen permeable inorganic membrane, proton-conveying ceramic and a combination thereof.

In step 703, oxygen gas is formed, in the catalyst compartment 630, by a chemical reaction of water with the oxidized metal species in the presence of a catalyst. The oxidized metal species is reduced in the catalyzed reaction, forming the reduced-form of the oxidized species (that is, the reduced metal species). The chemical oxidation of water by the oxidized metal species to form oxygen can be depicted by chemical equation (1):

2M^{m+}+H₂O→2Mⁿ⁺+½O₂+2H⁺ (1)

Where ‘M’ represents the metal species, M^{m+} represents the oxidized metal species, and Mⁿ⁺ represents the reduced metal species. In chemical equation (1), the oxidized metal species M^{m+} is reduced to Mⁿ⁺, while oxygen within water is oxidized to molecular oxygen gas. The catalyst, while taking part in the chemical process depicted in chemical equation (1), is not chemically transformed, therefore, the catalyst is not included within chemical equation (1).

The oxidized metal species M^{m+}, may be conveyed to the catalyst compartment 630 from the anodic compartment 610 as described above, or may be conveyed to the catalyst compartment 630 from one or both of the anodic 610 and cathodic 620 compartments.

Returning to the configuration depicted in FIG. 6A, the oxidized metal species is believed to conveyed to the catalyst compartment 630 substantially by diffusion due to the positive current flow from the anodic compartment 610 through the catalyst compartment 630 to cathodic 620 compartment. The reduced metal species, Mⁿ⁺, is conveyed from the catalysis compartment 630 to one or both of the catholic 620 and anodic 610 compartments. In some configurations, the reduced metal species may be conveyed from the catalysis compartment 630 to one or both of the anodic 610 and cathodic 620 compartments by diffusion. In some configurations, the reduced metal species may be conveyed from the catalysis compartment 630 to the anodic compartment 610 by lines 641 and 643 (such as, diffusion by electrochemical or electric potential gradient and/or concentration gradient) and/or a non-diffusion motive force (including without limitation positive or negative pressure, gravitational flow, and the like). In some configurations, the reduced metal species may be conveyed from the cathodic compartment 620 to the anodic compartment 610 by lines 642 and 643 (such as, diffusion by electrochemical or electric potential gradient and/or concentration gradient) and/or a non-diffusion motive force (including without limitation positive or negative pressure, gravitational flow, and the like).

Referring to the configuration depicted in FIG. 6B, the oxidized metal species is preferably conveyed to the catalysis compartment 630 from the anodic compartment 610 through line 652 (such as, but not limited by pumping). Moreover, oxidized metal species may be conveyed (such as, but not limited to pumping) to the catalysis compartment 630 from the cathodic compartment 620 by lines 651 and 652 (such as, but not limited to by pumping). Line 652 is interconnected to catalyst compartment inlet 608. The reduced metal species, Mⁿ⁺, is conveyed from the catalysis compartment 630 to one or both of the catholic 620 and anodic 610 compartments. In some configurations, the reduced metal species is preferably conveyed from the catalysis compartment 630 by line 653 (such as, but not limited to pumping) to the anodic compartment 610. Line 653 is interconnected to catalyst compartment outlet 609.

Returning to the configuration depicted in FIG. 6C, the conveyance of the oxidized metal species by diffusion and pumping was discussed above. The reduced metal species is preferably conveyed from the cathodic compartment 620 to anodic 610 by diffusion when the porous barrier 631 separates the anodic 610 and cathodic 620 compartments. In some configurations, line 663 conveys (such as, but not limited to pumping) the reduced metal species from the cathodic compartment 620 to the anodic compartment 610.

Referring to the configuration depicted in FIG. 6D, the oxidized metal species is preferably conveyed to the catalysis compartment 630 from anodic compartment 610 by lines 672 and 674 (such as, but not limited to pumping). Moreover, the oxidized species may be conveyed to the catalysis compartment 630 from cathodic compartment 620 by lines 673 and 672 (such as, but not limited to pumping). Line 672 is interconnected to catalysis compartment inlet 608. The reduced metal species, Mⁿ⁺, is conveyed from the catalysis compartment 630 to one or both of the catholic 620 and anodic 610 compartments. In some configurations, the reduced metal species is preferably conveyed from the catalysis compartment 630 by lines 675 and 676 (such as, but not limited to pumping) to the anodic compartment 610. In some configurations, lines 675, 677, and 678 convey hydronium ions, an aqueous from of the protons formed in chemical equation (1), from the catalysis compartment 630 and anodic compartment 610 to the cathodic compartment 620. Line 675 is interconnected to catalyst compartment outlet 609 and one or more of lines 676, 677, and 678.

Referring to the configuration depicted in FIG. 6E, the oxidized metal species may be conveyed by diffusion to the catalysis compartment 630 from the cathodic compartment 620, the diffusion is preferably through the porous barrier 631 separating the cathodic 620 and catalyst 630 compartments. In some configurations, the oxidized species is conveyed (such as, but not limited to pumping) to the catalysis compartment 630 through line 684. Preferably, line 684 is interconnected to one or both of line 681 from the anodic compartment 610 and line 683 from the cathodic compartment 620. Moreover, line 684 is interconnected to the catalysis compartment inlet 608. The reduced metal species, Mⁿ⁺, is conveyed from the catalysis compartment 630 to the anodic compartment 610 by line 685 (such as, but not limited to pumping). Line 685 is interconnected to catalyst compartment outlet 609.

Returning to the configuration depicted in FIG. 6F, the oxidized metal species may be conveyed to the catalysis compartment 630 from the cathodic compartment 620 by lines 692 and 695 (such as, but not limited to by pumping). Moreover, the oxidized metal species may conveyed to the from the anodic compartment 610 to the catalyst compartment 630 by lines 694 and 695 (such as, but not limited to by pumping). Line 695 is interconnected to the catalyst compartment inlet 608 and, respectively, to lines 692 and 694. The reduced metal species, Mⁿ⁺, is conveyed from the catalysis compartment 630 to the anodic compartment 610 by line 693 (such as, but not limited to pumping). Line 693 is interconnected to catalyst compartment outlet 609.

In some configurations, the catalyst is in the form of a catalyst bed substantially supported within the catalyst compartment 630. The catalyst is preferably an electron conductor. The catalyst may comprise platinum group metal-containing materials. The platinum group metal-containing material may comprise a platinum group metal foil, a nano-particulate comprising a platinum group metal alone or supported on a conductive material (such as, carbon nano-tubes or activated carbon), nano-crystalline material comprising a platinum group metal alone or supported on a conductive material. Other supports for the platinum group metal-containing material include lead-containing materials, lead oxide-containing materials, lead dioxide-containing materials, other metal oxides (such as ZrO, TiO₂, a rare earth oxide, and the like), carbon nanotubes, activated carbons, graphite, titanium-containing materials, zeolites, or combinations thereof. In accordance with some embodiments, the conductive material comprises one or more of carbon nano-tubes, graphene, graphite, carbon black and activated carbon. The support may or may not be electrically conductive. For example the support can be a semi-conductor, such as SiO₂. For example, some forms of carbon nano-tubes and graphene are semi-conductors.

In some configurations, the photoanode is composed of a semiconductor material having a suitable bandgap (BG). Photoanodes having a bandgap of 1.2 eV or more, when irradiated with corresponding electromagnetic energy (as respectively indicated in Table I) can generate sufficient electrochemical potential to carry out the electrolysis process—as such the electrochemical process 700 could be operated with little, if any, electrical power from power source 640. However, in some configurations comprising photoanodes having a bandgap of 1.2 eV or more electrical power from power source 640 can be supplied to the electrochemical process 700. Photoanodes having a bandgap of 1.2 eV or less, when irradiated with corresponding electromagnetic energy (as respectively indicated in Table I) typically will require at least some additional electrical energy for power source 640 to carry out the electrochemical process 700. The semiconductor is typically selected from the group consisting essentially of tungstic oxide (WO₃), titanium dioxide (TiO₂), titanium oxide (TiO), indium antimonide (InSb), lead (II) selenide (PbSe), lead (II) telluride (PbTe), indium (III) arsenide (InAs), lead (II) sulfide (PbS), germanium (Ge), gallium antimonide (GaSb), indium (III) nitride (InN), iron disillicide (FeSi₂), silicon (Si), copper (II) oxide (CuO), indium (III) phosphide (InP), gallium (III) arsenide (GaAs), cadmium telluride (CdTe), selenium (Se), copper (I) oxide (Cu₂O), aluminum arsenide (AlAs), zinc telluride (ZnTe), gallium (III) phosphide (GaP), cadmium sulfide (CdS), aluminum phosphide (AlP), zinc selenide (ZnSe), silicon carbide (SiC), zinc oxide (ZnO), titanium (IV) oxide (TiO₂), gallium (III) nitride (GaN), zinc sulfide (ZnS), ITO or indium tin oxide (In₂O₃)_{0.9}(SnO₂)_{0.1}, diamond (C), aluminum nitride (AlN) or mixtures thereof. Non-limiting example of some suitable semi-conductors are provided in Table I.

TABLE I

| Name | Formula | BG (eV) | λ (nm) |
|---|---|---|---|
| Indium antimonide | InSb | 0.17 | 7293 |
| Lead(II) selenide | PbSe | 0.27 | 4592 |
| Lead(II) telluride | PbTe | 0.29 | 4275 |
| Indium(III) arsenide | InAs | 0.36 | 3444 |
| Lead(II) sulfide | PbS | 0.37 | 3351 |
| Germanium | Ge | 0.67 | 1851 |
| Gallium antimonide | GaSb | 0.7 | 1771 |
| Indium(III) nitride | InN | 0.7 | 1771 |
| Iron disilicide | FeSi2 | 0.87 | 1425 |
| Silicon | Si | 1.11 | 1117 |
| Copper(II) oxide | CuO | 1.2 | 1033 |
| Indium(III) phosphide | InP | 1.35 | 918 |
| Gallium(III) arsenide | GaAs | 1.43 | 867 |
| Cadmium telluride | CdTe | 1.49 | 832 |
| Aluminium antimonide | AlSb | 1.6 | 775 |
| Cadmium selenide | CdSe | 1.73 | 717 |
| Selenium | Se | 1.74 | 713 |
| Copper(I) oxide | Cu2O | 2.1 | 590 |
| Aluminium arsenide | AlAs | 2.16 | 574 |
| Zinc telluride | ZnTe | 2.25 | 551 |
| Gallium(III) phosphide | GaP | 2.26 | 549 |
| Cadmium sulfide | CdS | 2.42 | 512 |
| Aluminium phosphide | AlP | 2.45 | 506 |
| Gallium(II) sulfide | GaS | 2.5 | 496 |
| Zinc selenide | ZnSe | 2.7 | 459 |
| Silicon carbide | SiC | 2.86 | 434 |
| Zinc oxide | ZnO | 3.37 | 368 |
| Titanium(IV) oxide | TiO2 | 3.2 | 387 |
| Gallium(III) nitride | GaN | 3.4 | 365 |
| Zinc sulfide | ZnS | 3.6 | 344 |
| ITO (Indium Tin Oxide) | (In₂O₃)_{0.9}(SnO₂)_{0.1} | 4.0 | 310 |
| Diamond | C | 5.5 | 225 |
| Aluminium nitride | AlN | 6.3 | 197 |

Preferably, the semi-conductor has a band-gap from about 0.5 to about 6.3 eV, more preferably from about 1.0 to about 4 eV. Preferably, the semi-conductor absorbs electromagnetic energy (that is has a lambda) from about 7,500 to about 195 nm, more preferably from about 1,000 to about 300 nm.

The catalyst may comprise a nano-particulate material. Preferably, the nano-particulate material comprises a platinum group metal. While not wanting to be limited by example, the nano-particulate material preferably has an average particle size from about 0.1 nm to about 200 nm. The nano-particulate material commonly has an average particle size from about 0.5 nm to about 100 nm. The nano-particulate material typically has an average surface area of at least about 50 m²/g, more typically an average surface area of at least about 100 m²/g, even more typically an average surface area of at least about 150 m²/g, yet even more typically an average surface area of at least about 250 m²/g, yet even more typically an average surface area of at least about 350 m²/g, or yet even more typically the nano-particulate material has an average surface area of at least about 400 m²/g.

The nano-particulate material may comprise non-discrete particulates of the platinum group metal. The non-discrete platinum group particulate may be in the form of ordered aggregates, and/or in the form of nano-crystalline domains. Furthermore, the non-discrete particulates of the platinum group metal may or may not be supported.

Commonly, from about 1 to about 99 wt % of the platinum group metal comprising the catalyst is in the form of non-discrete particulates. More commonly, from about 2 to about 95 wt % of the platinum group metal is in the form of non-discrete particulates, even more commonly from 2 to about 90 wt % of the platinum group metal is in the form of non-discrete particulates, yet even more commonly from 3 to about 80 wt % of the platinum group metal is in the form of non-discrete particulates, still yet even more commonly from 4 to about 60 wt % of the platinum group metal is in the form of non-discrete particulates, yet still more commonly from 5 to about 40 wt % of the platinum group metal is in the form of non-discrete particulates, yet still even more commonly from 6 to about 30 wt % of the platinum group metal is in the form of non-discrete particulates, still yet even more commonly from 7 to about 20 wt % of the platinum group metal is in the form of non-discrete particulates, still yet even more commonly from 8 to about 15 wt % of the platinum group metal is in the form of non-discrete particulates, or still yet even more commonly from 9 to about 10 wt % of the platinum group metal is in the form of non-discrete particulates.

In some embodiments, the catalyst commonly has an average surface area of at least about 1 m²/g, more commonly an average surface area of at least about 10 m²/g, even more commonly an average surface area of at least about 50 m²/g, yet even more commonly an average surface area of at least about 80 m²/g, still yet even more commonly an average surface area of at least about 100 m²/g, still yet even more commonly an average surface area of at least about 150 m²/g, or still yet even more commonly an average surface area at least about 200 m²/g.

In some embodiments, the catalyst includes activated carbon. The catalyst may or may not be in the form of a nanoparticle catalyst. Furthermore, the catalyst may or may not comprise a platinum group metal. The activated carbon may have an average particle size from as small as about 0.5 nm or smaller to as large as about 10 microns or larger. The activated carbon commonly have an average surface area from about 500 m²/g to about 5,000 m²/g, more commonly from about 1,000 m²/g to about 2,500 m²/g, or even more commonly from about 1,500 m²/g to about 2,000 m²/g. Preferably, the activated carbon has an average surface area of about 1,800 m²/g.

In some embodiments, the catalyst comprises carbon nanotubes. Moreover, the catalyst may or may not include non-discrete particulate, such as non-discrete particulates of a platinum group metal. The carbon nanotubes can be single or multi walled carbon nanotubes. Preferably, the carbon nanotubes are multi-walled carbon nanotubes. Typically, the carbon nanotubes have an average outside diameter from about 1 nm to about 100 nm, more typically the average outside diameter is from about 5 nm to about 50 nm, or even more typically the average outside diameter is from about 10 nm to about 30 nm. Commonly the carbon nanotubes have an average surface area greater than about 100 m²/g, more commonly the carbon nanotubes have an average surface area greater than about 1,000 m²/g, or even more commonly the carbon nanotubes have an average surface greater than about 2,000 m²/g.

In step 710, the oxygen gas is collected. The oxygen gas collection may include, without limitation, a positive, ambient or negative pressure bleeding off of the atmosphere above the catalyst compartment 630 to form a bleed-off stream, the bleed-off stream containing the molecular oxygen gas. The molecular oxygen can be removed from the bleed-off stream by any process known within the art, such as, but not limited to sparging processes, zeolites, gas absorption processes, gas dehydration process, pressure swing adsorption, gas separation membranes, combinations thereof or such to form a concentrated oxygen stream and an oxygen-depleted gaseous stream. The oxygen-depleted gaseous stream may be returned to the catalyst compartment 630 to further sweep molecular oxygen gas from the atmosphere about the catalyst compartment 630.

Returning to chemical equation (1) of step 703, the products of the chemical reaction depicted in equation (a) are oxygen gas, protons (H⁺ and/or hydronium ion H₃O⁺) and reduced metal species (Mⁿ⁺).

In step 705, the protons (H⁺) and/or protons in the form hydronium ions (H₃O⁺) are electrochemical reduced to hydrogen gas (H₂). The protons and/or hydronium ions may be a component of the anolyte solution and/or may one of the products formed along with oxygen in the catalyst compartment 630, as depicted in chemical equation (1). Unless explicitly indicating differently, the terms proton(s) and hydronium ion(s) H₃O⁺ will be used interchangeably herein. The electrochemical reduction of hydronium ions to produce hydrogen is depicted by chemical equation (2):

2e⁻+2H₃O⁺→H₂+2H₂O (2)

The hydrogen gas is preferably formed in the cathodic compartment 620. More preferably, the hydrogen gas is formed substantially about the cathode 621. Moreover, the cathode typically having an electric potential being applied thereto. The electrochemical potential of the cathode is commonly from about 0.01 to about 3.0 volts versus SHE (standard hydrogen electrode). Moreover, the electrical power source 640 may impose an electrical current flow between the anode 611 and cathode 621. Preferably, the electrochemical potential of the cathode is from about 0.5 to about 2.5 volts versus SHE, more preferably from about 1.0 to about 2.0 volts versus SHE.

While not wanting to be bound by theory, the cathode 621 is an electron source for the reduction of protons (and/or hydronium ions) to hydrogen gas. In some configurations, anode 611 provides at least some of the electrons to the cathode 621. The anode 611 may provide at most, if not all, of the electrons supplied to the cathode 621.

In some configurations, an optional electrical power source 640 provides at least some of the electrical potential for generating electrons at anode 611 and supplying electrons to cathode 621. The electrical power source 640 may be any device for applying an electrochemical potential to one or both of the anode 611 and cathode 621. It can be appreciated that, higher cathodic current densities are preferable to smaller cathodic current densities. In step 720, the hydrogen gas is collected. The hydrogen gas collection process may include, without limitation, a positive, ambient or negative pressure bleeding off of the atmosphere above the cathodic compartment 620 to form a bleed-off stream. The molecular hydrogen gas can be collected from the bleed-off stream by any process known within the art, such as, but not limited to sparging processes, zeolites, gas absorption processes, gas dehydration process, pressure swing adsorption, gas separation membranes, combinations thereof or such to form a concentrated molecular hydrogen stream and an hydrogen-deleted gaseous stream. The hydrogen-depleted gaseous stream may be returned to the collection step 720 to further sweep molecular hydrogen from the cathodic compartment 620.

It can be appreciated that the catalyst and the metal species mediator are not consumed in process 700. As such molecular hydrogen and oxygen derived from water without the consumption of other chemical species. The overall, net chemical reaction for process 700 is depicted chemical equation (3):

H₂O→½O₂H₂ (3)

Some of the advantages of the process 700 include one or more of: commonly operating at a temperature from about 15 to about 100 degrees Celsius; commonly operating at ambient pressures; typically lacking and/or being devoid of a precipitation process; typically lacking and/or being devoid of a dissolution process; substantially lacking or being devoid of carbon dioxide and/or greenhouse gas emissions; typically lacking and/or being devoid of sacrificial reagents other than the first and/or second reactant; substantially lacking or being devoid of large energy requirements; commonly forming oxidation and reduction products separately, thereby simplifying their separation, that is, hydrogen and oxygen can be formed separately, thereby simplifying their separation; and typically lacking and/or being devoid of one or both of substantially corrosion and hazardous chemicals.

Preferably, the metal species has a solution concentration of at least about 0.001 M, a solution concentration of at least about 0.005 M, a solution concentration of at least about 0.01 M, a solution concentration of at least about 0.05 M, a solution concentration of at least about 0.1 M, a solution concentration of at least about 0.25 M, a solution concentration of at least about 0.5 M, a solution concentration of at least about 0.75 M, a solution concentration of at least about 1 M, a solution concentration of at least about 2 M, a solution concentration of at least about 3 M, or a solution concentration of at least about 4 M. More preferably, the metal species comprises cerium at one of the above solution concentrations. Even more preferably, the cerium is derived from cerium sulfate, cerium methanesulfonate, or mixture thereof.

### EXAMPLES

### Example 1

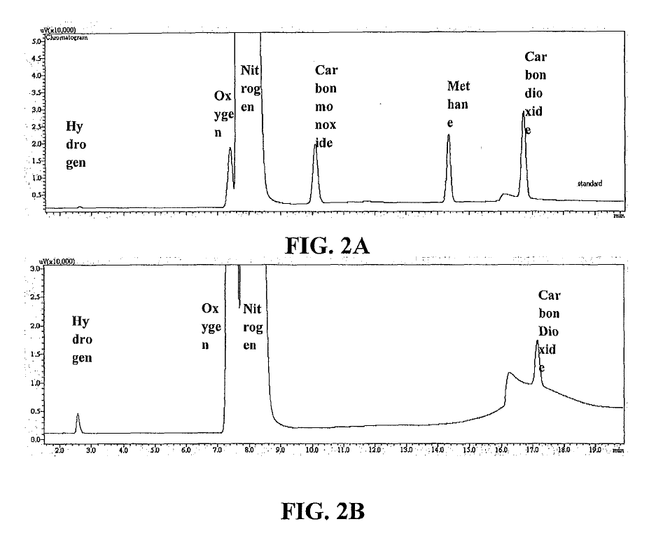

A clear, colorless solution of 0.15 M Ce₂(SO₄)₃ in 100 mL of 0.35 N sulfuric acid was placed in a ultra-violet light transparent quartz tube. A ultra-violet excimer laser having a wavelength of about 248 nm was pulsed about 14,000 times for about approximately 12 minutes. Each laser pulse had a duration of about 20 nanoseconds. The net laser irradiation time was about 288 microseconds. The laser beam was passed through the quartz tube. The application of the laser beam generated bubbles in the solution and produced a yellow color consistent with the formation of Ce (IV) sulfate. FIG. 2A is gas chromatography mass spectral analysis of the atmosphere above the solution prior to irradiation of the 0.15 M Ce₂(SO₄)₃ in 0.35 N sulfuric acid solution with the ultra-violet excimer laser, the atmosphere above the solution substantially lacks hydrogen. FIG. 2B is gas chromatography mass spectral analysis of the atmosphere above the solution 0.15 M Ce₂(SO₄)₃ of 0.35 N sulfuric acid after irradiation of the solution with the ultra-violet excimer laser, the atmosphere above the solution substantially comprises hydrogen gas.

### Example 2

This is an example that a rare-earth mediated electrochemical redox reaction can produce hydrogen gas from an acidic electrolyte. Furthermore, the hydrogen gas can be produced at an applied potential below that required for the practical electrolysis of water.

The electrolyte comprised a cerium (III) methane sulfonic acid solution prepared by dissolving cerium (III) carbonate in concentrated methane sulfonic acid. The cerium methane sulfonic acid solution had a cerium concentration of about 0.9 M and a methane sulfonic acid concentration of about 1.2 M.

The cerous methane sulfonic acid solution was added to a simple galvanic cell. The cathode comprised of two separate platinum wires t twisted together in a double helix fashion and soldered to an electric wire. The cathode was immersed in the cerium methane sulfonic acid electrolyte. The anode comprised a 1.5″×0.5″ section of a PbO₂ from a car battery. The galvanic cell was then sealed with the rubber stoppers. A rigid tube interconnected a gas chromatograph with the cathode compartment headspace. A DC power supply was electrically interconnected to the anode and cathode. The DC potential applied to the system was slowly increased from 0.0 volts until gas evolution was observed on the cathode. As soon as gas evolution was observed the GC began collecting samples and analyzed the headspace gas composition in the cathode chamber about every one-minute. The applied potential was increased to about 1.2 volts and then maintained throughout the duration of the experiment. The experiment lasted about 17 minutes.

Within the first 3 minutes of the experiment hydrogen gas was detected at 0.03% (on a molar percentage basis). It should be noted that the galvanic cell was not purged with an inert gas prior to or during the experiment. After 17 minutes of reaction time, the final concentration of hydrogen gas increased to 9.6% molar concentration, see Table III. This measured concentration is well above the normal molar percent that is detectable in ambient air, which is negligible or typically below the level of detection 0.001% or 10 ppm, as seen in Table III. This example presents results for the oxidation of soluble cerium (III) in methanesulfonic acid provides sufficient current necessary to reduce H⁺ to H₂ gas at a potential below that required for the electrolysis of water.

| Cathode Chamber | | Ambient Air | |
|---|---|---|---|
| Time | H₂ % | Compond | Molar % |
| 0 | BDL | H₂ | BDL |
| 2 | BDL | O₂ | 20.2 |
| 3 | 0.03 | N₂ | 79.5 |
| 4 | 0.17 | CO₂ | 0.2 |
| 6 | 0.45 | | |
| 8 | 1.09 | | |
| 9 | 2.18 | | |
| 10 | 3.60 | | |
| 12 | 5.20 | | |
| 13 | 6.60 | | |
| 15 | 8.02 | | |
| 17 | 9.57 | | |

Table II (left) and Table III (right): Table II displays concentration of hydrogen over time while table III displays the concentration of N₂, O₂, H₂, and CO₂ in the ambient air

### Example 3

A solution was formed by adding about 25 mL of 0.2 M Ce(SO₄)₂ to an Erlenmeyer flask with about 0.20 g of activated carbon having about 10 wt % nano-crystalline platinum loading (obtained from Sigma Aldrich). The nano-crystalline platinum loaded activated carbon had a surface area from about 10 to about 80 m²/g. The solution initially had a yellow color, characteristic of cerium (IV). The mixture was stirred in a water bath at a temperature of about 20° C. for about 30 minutes. Over this 30-minute period the mixture continually produced gas bubbles (which gas bubbles were believed to be oxygen gas optionally with carbon dioxide gas). At the end of this 30-minute period the solution was filtered, the filtrate was clear and colorless, which is consistent with cerous (III) sulfate being formed. The change in color from yellow to colorless is indicative of the reduction of Ce (IV) to Ce (III). The reaction produced gas at 20 degrees Celsius and in the absence of an applied electric potential.

### Example 4

A solution was formed by adding 50 mL of 0.01 M Ce(SO₄)₂ in 2 M H₂SO₄ to an erlenmeyer flask. The solution had a yellow color, indicative of cerium (IV). The solution was heated to a temperature of about 44° C. under magnetic stirring. To the heated solution, about 0.2 grams of Industrial Grade Multi-Walled Carbon Nanotubes (Sun Innovations, SN-5906837) were added and subsequently dispersed in the solution. After stirring for about 1 hour at temperature of about 44° C., the yellow solution became colorless, indicative of cerium (IIII). The process of example is consistent with the reduction of Ce(IV) to Ce(III).

### Example 5

A solution was formed by adding about 50 mL of 0.01 M Ce(SO₄)₂ in about 2 M H₂SO₄ to an erlenmeyer flask. The solution was heated to a temperature of about 44° C. under magnetic stirring. To the heated solution, about 0.4 grams of activated carbon powder (DARCO, Norit N.V.) were added to and dispersed in the solution. After stirring for about an hour at 44° C., the solution was filtered. The solution filtrate was colorless. The colorless filtrate is consistent with cerous (III) sulfate. The color change from yellow, Ce (IV), to colorless, Ce (III) is indicative with the reduction of Ce (IV) to Ce (III).

### Example 6

An experiment was performed to demonstrate that platinum catalyzes the reduction of cerium (IV) to cerium (III) in an acidic environment providing the driving force to oxidize water to O₂ gas and H⁺ or H₃O⁺

The experimental parameters were as follows:

Solutions:
Ceric methanesulphonic acid at a concentration of 0.1M cerium and 0.13 M methanesulphonic acid.
The solution was synthesized by dissolving cerium carbonate, Ce₂(CO₃)₃ in concentrated methanesulphonic acid to a 0.9 M cerium concentration and 1.2 M methanesulphonic acid. The solution was oxidized through electrolytic conversion (Mediated electrosynthesis with cerium (IV) in methanesulphonic, R. M. Spotnitz, R. P. Kreh, J. T. Lundquist, P. J. Press: Jan. 3, 1989). The solution was then diluted using deionized (DI) water to achieve a 0.1 M cerium methanesulphonic acid.

Analytical:

All gas analysis was performed by an Agilent 490 Micro GC which has a detection limit of 0.001 molar percent. The color of the solution was analyzed via UV-vis Perkin Elmer Lambda 25.

Procedure:

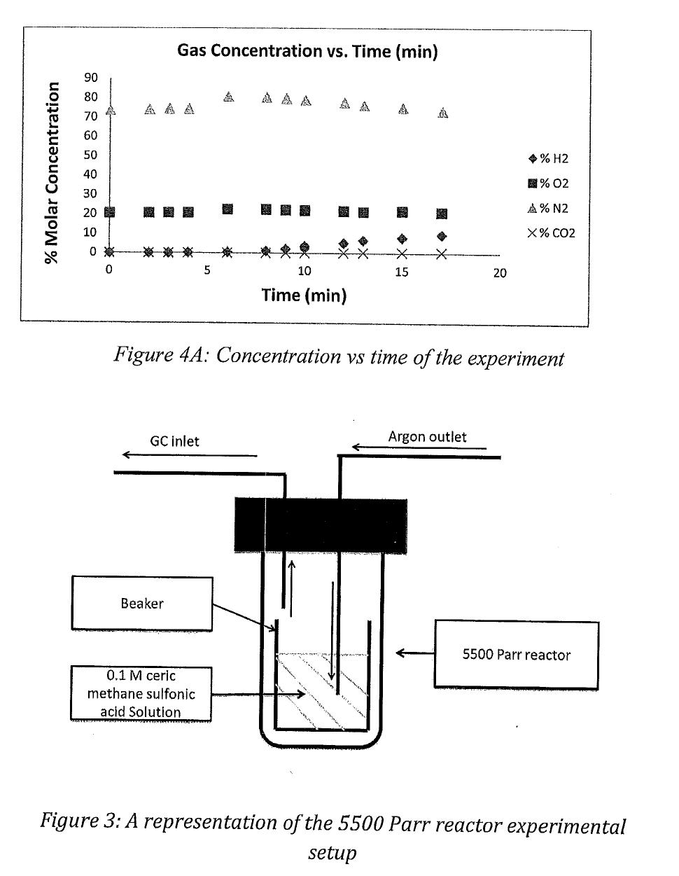

As shown by FIG. 3, a 5500 Parr reactor was prepared by installing an outlet that is connected to the GC and an inlet that is connected to an argon tank. The inlet tube connected to the argon extends the full length of the reactor to ensure that the tube is submerged in the solution. A 150 mL beaker was placed into the reactor and 100 mL of 0.1 M eerie methanesulphonic acid was added to the beaker. Four pieces of platinum foil (25×25×0.025 mm each) were added to the solution and then the reactor was closed. The system was purged with argon for 60 minutes. After the purge the Parr reactor outlet was connected to the GC inlet and the reactor was heated to 70° C. Gas measurements were taken every 15 minutes for 8 hours. After the 8 hour reaction time the beaker was removed and the solution was analyzed by UV-vis.

Results:

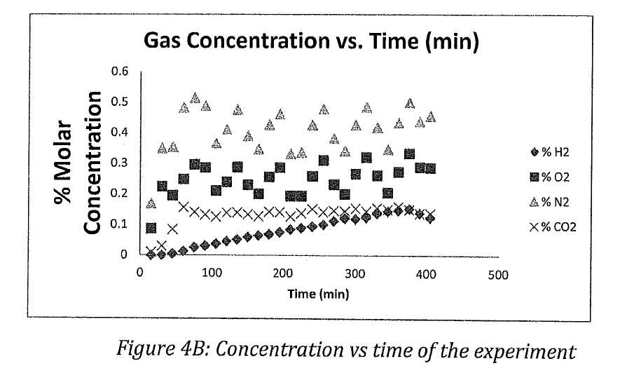

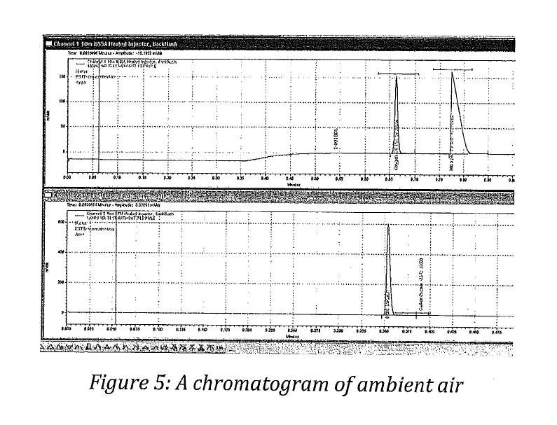

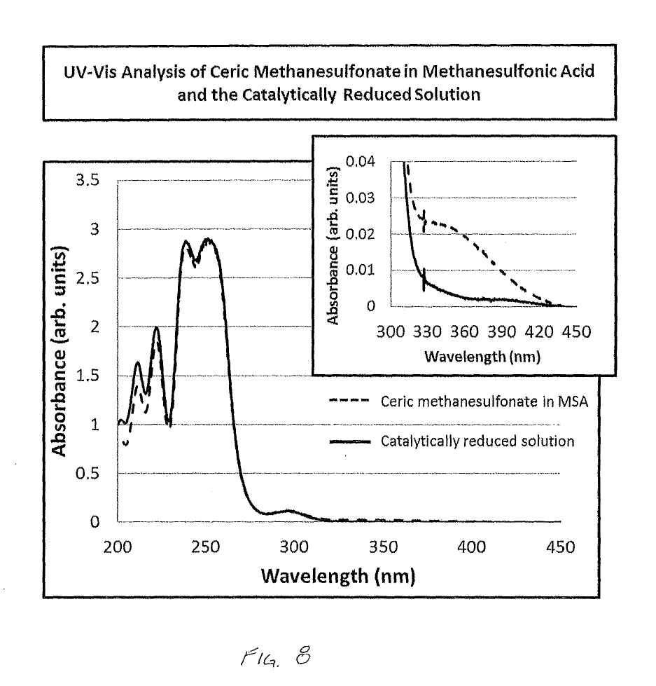

The gas composition was measured by GC and reported on a molar percent basis. The results are shown in FIGS. 4A and 4B; FIG. 8 depicts the UV-vis spectra of the starting solution, eerie methane sulfonic acid, and the final experimental solution; and FIG. 5 depicts a chromatograph of ambient air. At the termination of the experiment <1.2 molar % of the gas present was detectable by the GC, whereas ˜98 molar % of the sample is assumed to be argon, which is undetectable by GC in its current configuration. Unfortunately a leak within the system could not be prevented allowing some amount of ambient air to diffuse in, however the ratio of N₂ to O₂ was much lower than that of ambient air. Table V shows a measurement of ambient air N₂ to O₂ of 3.9.0 while Table 1V indicates that the N₂ to O₂ ratio is constant at 1.7. Ambient air contains a N₂ to O₂ ratio of 4:1 while the average ratio in the reactor is 1.7:1.

The solution color before and after reaction was analyzed via UV-vis and the data is consistent with the visual observation that the color of the solution changed from yellow to colorless. FIG. 8 shows a detailed view of the UV-vis spectra in the range of 330 to 420 nm, which indicates absorbance in the visible range by the ceric methanesulfonic acid solution while there is no absorbance in the cerous methanesulfonic acid solution.

TABLE IV
Analytical data from the experiment (all concentrations are on a percent molar basis).

| Time Imin) | % H2 | % O2 | % N2 | % CO2 | % N2/O2 |
|---|---|---|---|---|---|
| 15 | <0.001 | 0.087 | 0.169 | 0.010 | 1.9 |
| 30 | <0.001 | 0.224 | 0.349 | 0.030 | 1.6 |
| 45 | 0.005 | 0.195 | 0.353 | 0.085 | 1.8 |
| 60 | 0.013 | 0.248 | 0.482 | 0.156 | 1.9 |
| 75 | 0.026 | 0.296 | 0.514 | 0.141 | 1.7 |
| 90 | 0.031 | 0.286 | 0.488 | 0.133 | 1.7 |
| 105 | 0.038 | 0.211 | 0.365 | 0.126 | 1.7 |
| 120 | 0.046 | 0.239 | 0.410 | 0.139 | 1.7 |
| 135 | 0.052 | 0.288 | 0.476 | 0.140 | 1.7 |
| 150 | 0.060 | 0.230 | 0.389 | 0.134 | 1.7 |
| 165 | 0.065 | 0.201 | 0.347 | 0.128 | 1.7 |
| 180 | 0.069 | 0.256 | 0.426 | 0.143 | 1.7 |
| 195 | 0.076 | 0.287 | 0.462 | 0.141 | 1.6 |
| 210 | 0.085 | 0.194 | 0.331 | 0.127 | 1.7 |
| 225 | 0.090 | 0.194 | 0.336 | 0.138 | 1.7 |
| 240 | 0.095 | 0.259 | 0.426 | 0.152 | 1.6 |
| 255 | 0.101 | 0.311 | 0.479 | 0.142 | 1.5 |
| 270 | 0.113 | 0.232 | 0.382 | 0.147 | 1.6 |
| 285 | 0.122 | 0.201 | 0.342 | 0.145 | 1.7 |
| 300 | 0.120 | 0.267 | 0.428 | 0.154 | 1.6 |
| 315 | 0.125 | 0.321 | 0.485 | 0.145 | 1.5 |
| 330 | 0.138 | 0.262 | 0.419 | 0.156 | 1.6 |
| 345 | 0.145 | 0.206 | 0.347 | 0.151 | 1.7 |
| 360 | 0.148 | 0.274 | 0.434 | 0.160 | 1.6 |
| 375 | 0.153 | 0.334 | 0.500 | 0.150 | 1.5 |
| 390 | 0.139 | 0.289 | 0.438 | 0.138 | 1.5 |
| 405 | 0.125 | 0.287 | 0.456 | 0.138 | 1.6 |

TABLE V
Ambient Air

| Compound | Molar % |
|---|---|
| H2 | <0.001 |
| O2 | 20.15 |
| N2 | 79.52 |
| CO2 | 0.17 |
| N2/O2 Ratio | 3.9 |

Conclusion:

The experimental data reported herein is consistent with the proposed cerium-mediated oxidation of water. The data generated by the GC measurement of the gas atmosphere above the reaction solution after adding the Pt catalyst shows a N₂:O₂ ratio of 1.7 as opposed to the N₂:O₂ ratio of 3.9 in ambient air. This data is consistent with the generation of O₂ gas within this Pt-catalyzed reaction, and the fact that the decreased N₂:O₂ ratio was consistent from the first data point (t=15 min) indicates that O₂ was generated in the system very early on in the experiment. In addition, the visual observation of the solution color change pre- and post-reaction, as evidenced by the UV-vis data presented, is consistent with the reduction of cerium (IV) (eerie ion) to cerium (III) (cerous ion). Taken together, this data supports the theory that the catalyzed reduction of Ce(IV) to Ce(III) provides the driving force to oxidize water, generating O_{2(g)} and H⁺_{(aq)} or H₃O⁺_{(aq)}.

A number of variations and modifications of the disclosure can be used. It would be possible to provide for some features of the disclosure without providing others.

The present disclosure, in various aspects, embodiments, and configurations, includes components, methods, processes, systems and/or apparatus substantially as depicted and described herein, including various aspects, embodiments, configurations, subcombinations, and subsets thereof. Those of skill in the art will understand how to make and use the various aspects, aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate preferred embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A process, comprising:
forming, in a cathodic compartment, hydrogen gas, wherein the cathodic compartment contains a cathode;
forming, in a catalyst compartment, oxygen gas by a one or more chemical reactions involving a catalyst; and
forming, in an anodic compartment, an electric current, wherein the anodic compartment contains an anode electrically interconnected with the cathode, wherein the anodic and cathodic compartments are in fluid communication and the catalyst compartment is in fluid communication with one or both of the anodic and cathodic compartments.

2. The process of claim 1, wherein one of the following is true:
i) the catalyst compartment is in fluid communication with the anodic compartment;
ii) the catalyst compartment is in fluid communication with the cathodic compartment; and
iii) the catalyst compartment is in fluid communication with both the anodic and cathodic compartments.

2. The process of claim 1, wherein the catalyst comprises platinum.

3. The process of claim 2, wherein the platinum comprises one or both of nanocrystalline platinum, high surface area platinum, or a combination thereof.

4. The process of claim 1, wherein the catalyst is in the form of a catalyst bed.

5. The process of claim 4, wherein the catalyst bed comprises a porous catalyst bed.

6. The process of claim 5, wherein the porous catalyst is one of a macro-porous catalyst, micro-porous catalyst, or a mixture thereof.

7. The process of claim 1, wherein the catalyst is supported by one of activated carbon, carbon black, graphite, graphene, carbon nanotubes, high surface area amorphous carbon, and a mixture thereof.

8. The process of claim 1, wherein the catalyst comprises platinum loaded on a metal oxide.

9. The process of claim 1, wherein the catalyst is supported by a metal oxide that is at least one of an aluminum oxide, a rare earth oxide, and mixture thereof.

10. The process of claim 8, wherein the catalyst comprises from about 1 to about 90 wt % of platinum.

11. The process of claim 8, wherein the catalyst comprises from about 2 to about 25 wt % of platinum.

12. The process of claim 8, wherein the catalyst comprises about 10 wt % of platinum.

13. The process of claim 1, wherein the cathode comprises platinized platinum.

14. The process of claim 1, wherein the anode is a photoanode.

15. The process of claim 14, wherein the photoanode is selected from the group consisting essentially of tungstic oxide (WO₃), titanium dioxide (TiO₂), titanium oxide (TiO), indium antimonide (InSb), lead (II) selenide (PbSe), lead (II) telluride (PbTe), indium (III) arsenide (InAs), lead (II) sulfide (PbS), germanium (Ge), gallium antimonide (GaSb), indium (III) nitride (InN), iron disillicide (FeSi₂), silicon (Si), copper (II) oxide (CuO), indium (III) phosphide (InP), gallium (III) arsenide (GaAs), cadmium telluride (CdTe), selenium (Se), copper (I) oxide (Cu₂O), aluminum arsenide (AlAs), zinc telluride (ZnTe), gallium (III) phosphide (GaP), cadmium sulfide (CdS), aluminum phosphide (AlP), zinc selenide (ZnSe), silicon carbide (SiC), zinc oxide (ZnO), titanium (IV) oxide (TiO₂), gallium (III) nitride (GaN), zinc sulfide (ZnS), ITO or indium tin oxide (In₂O₃)_{0.9}(SnO₂)_{0.1}, diamond (C), aluminum nitride (AlN) and mixtures thereof.

16. The process of claim 14, wherein the photoanode is photoactivated by one or more of sun light, visible-light, and ultra-light.

17. The process of claim 15, wherein the sunlight is, before contacting with the anode, one or both of concentrated by one or more lenses and channeled by one or more optical fibers.

18. The process of claim 1, wherein the electric current is formed by one or both of chemical reaction and photoelectrochemical process.

19. The process of claim 18, wherein the forming of the electrochemical current further comprises oxidizing cerium (+3) to cerium (+4).

20. The process of claim 1, wherein the forming of the electric current further comprises:
forming cerium (+4) from cerium (+3) in the anodic compartment.

21. The process of claim 19, further comprising:
passing the formed cerium (+4) from the anodic compartment to the catalyst compartment.

22. The process of claim 1, wherein the forming of the oxygen gas further comprises:
forming cerium (+3) from cerium (+4) in the catalyst compartment.

23. The process of claim 20, further comprising:
passing the formed cerium (+3) from the catalyst compartment to the anodic compartment.

24. The process of claim 20, wherein the formation of the oxygen gas and cerium (+3) occurs in the absence of an applied electrical potential.

25. The process of claim 1, wherein the catalyst has a surface area of from about 0.001 m²/g to about 1,000 m²/g.

26. The process of claim 1, wherein the catalyst has a surface area of from about 30 m²/g to about 50 m2/g.

27. The process of claim 1, wherein anodic, cathodic and catalyst compartments contain an aqueous phase.

28. A process, comprising:
forming, in a catalyst compartment, oxygen gas by catalytic reduction of cerium (+4) to cerium (+3);
forming an electric current, in an anodic compartment containing an anode, by oxidizing cerium (+3) to cerium (+4);
forming, in a cathodic compartment containing a cathode, hydrogen gas; and
passing the cerium (+4) formed in the anodic compartment to the catalyst compartment and the cerium (+3) formed in the catalyst compartment to the anodic compartment wherein the anode and cathode are electrically interconnected.

29. The process of claim 28, wherein the anodic and cathodic compartments are in fluid communication through the catalyst compartment and wherein the cathodic, anodic and catalyst compartments contain an aqueous phase.

29. The process of claim 28, wherein the catalytic reduction of cerium (+4) to cerium (+3) comprises a catalyst, wherein the catalyst comprises platinum, and wherein the reduction of Ce(IV) provides the driving force for the oxidation of water.

30. The process of claim 29, wherein the catalyst has a surface area of from about 0.001 m²/g to about 1,000 m²/g.

31. The process of claim 29, wherein the catalyst has a surface area of from about 30 m²/g to about 50 m²/g.

32. The process of claim 29, wherein the catalyst comprises one of nano crystalline platinum, high surface area platinum, or a combination thereof.

33. The process of claim 29, wherein the catalyst is in the form of a catalyst bed.

34. The process of claim 33, wherein the catalyst bed is one of a macro-porous catalyst bed, a micro-porous catalyst bed, or a combination thereof.

35. The process of claim 29, wherein the catalyst is supported and wherein the catalyst support comprises one of activated carbon, a metal, a metal oxide, a rare earth composition, a cerium-containing composition, cerium oxide and a mixture thereof.

36. The process of claim 29, wherein the catalyst comprises platinum loaded on one or more of activated carbon, carbon black, graphite, graphene, carbon nanotubes, and high surface area amorphous carbon.

37. The process of claim 36, wherein the catalyst comprises from about 1 to about 90 wt % of platinum.

38. The process of claim 36, wherein the catalyst comprises from about 2 to about 25 wt % of platinum.

39. The process of claim 36, wherein the catalyst comprises about 10 wt % of platinum.

40. The process of claim 28, wherein the cathode comprises one or both of platinized platinum and high surface area platinum.

41. The process of claim 28, wherein the anode is a photoanode.

42. The process of claim 41, wherein the photoanode comprises a material selected from the group consisting essentially of tungstic oxide (WO₃), titanium dioxide (TiO₂), titanium oxide (TiO), indium antimonide (InSb), lead (II) selenide (PbSe), lead (II) telluride (PbTe), indium (III) arsenide (InAs), lead (II) sulfide (PbS), germanium (Ge), gallium antimonide (GaSb), indium (III) nitride (InN), iron disillicide (FeSi₂), silicon (Si), copper (II) oxide (CuO), indium (III) phosphide (InP), gallium (III) arsenide (GaAs), cadmium telluride (CdTe), selenium (Se), copper (I) oxide (Cu₂O), aluminum arsenide (AlAs), zinc telluride (ZnTe), gallium (III) phosphide (GaP), cadmium sulfide (CdS), aluminum phosphide (AlP), zinc selenide (ZnSe), silicon carbide (SiC), zinc oxide (ZnO), titanium (IV) oxide (TiO₂), gallium (III) nitride (GaN), zinc sulfide (ZnS), ITO or indium tin oxide (In₂O₃)_{0.9}(SnO₂)_{0.1}, diamond (C), aluminum nitride (AlN) and mixtures thereof.

43. The process of claim 41, wherein the photoanode is activated by one or more of sun light, a visible-light, and ultra-violet light.

44. The process of claim 43, wherein the sunlight is, before contacting with the anode, one or both of concentrated by one or more lenses and channeled by one or more optical fibers.

45. The process of claim 28, wherein the formation of the oxygen gas and cerium (+3) occurs in the absence of an applied electrical potential.

46. An electrochemical device, comprising:
an anodic compartment having an anode;
a cathodic compartment having a cathode; and
a catalyst compartment containing a catalyst, wherein the anodic and cathodic compartments are in fluid communication and the catalyst compartment is in fluid communication with at least one of the anodic and cathodic compartments, wherein the anode and cathode are electrically interconnected.

47. The device of claim 46, wherein the catalyst has a surface area of from about 0.001 m²/g to about 1,000 m²/g.

48. The device of claim 47, wherein the catalyst has a surface area of from 30 m²/g to about 50 m²/g.

49. The device of claim 47, wherein the catalyst comprises platinum.

50. The process of claim 49, wherein the platinum comprises one or both of nanocrystalline platinum and high surface area platinum.

51. The device of claim 46, wherein the catalyst comprises one of a macro-porous catalyst bed, micro-porous catalyst bed or combination thereof.

52. The device of claim 46, wherein the catalyst is supported and wherein the catalyst support comprises one or more of activated carbon, carbon black, graphite, graphene, carbon nanotubes, and high surface area amorphous carbon.

53. The device of claim 46, wherein the catalyst comprises platinum loaded on one or more of activated carbon, carbon black, graphite, graphene, carbon nanotubes, and high surface area amorphous carbon.

54. The device of claim 53, wherein the catalyst comprises from about 1 to about 90 wt % of platinum.

55. The device of claim 53, wherein the catalyst comprises from about 2 to about 25 wt % of platinum.

56. The device of claim 53, wherein the catalyst comprises about 10 wt % of platinum.

57. The device of claim 46, wherein the cathode comprises one or more of platinum, platinized platinum and high surface area platinum.

58. The device of claim 46, wherein the anode comprises a photoanode comprising a material selected from the group consisting of tungstic oxide (WO₃), titanium dioxide (TiO₂), titanium oxide (TiO), indium antimonide (InSb), lead (II) selenide (PbSe), lead (II) telluride (PbTe), indium (III) arsenide (InAs), lead (II) sulfide (PbS), germanium (Ge), gallium antimonide (GaSb), indium (III) nitride (InN), iron disillicide (FeSi₂), silicon (Si), copper (II) oxide (CuO), indium (III) phosphide (InP), gallium (III) arsenide (GaAs), cadmium telluride (CdTe), selenium (Se), copper (I) oxide (Cu₂O), aluminum arsenide (AlAs), zinc telluride (ZnTe), gallium (III) phosphide (GaP), cadmium sulfide (CdS), aluminum phosphide (AlP), zinc selenide (ZnSe), silicon carbide (SiC), zinc oxide (ZnO), titanium (IV) oxide (TiO₂), gallium (III) nitride (GaN), zinc sulfide (ZnS), ITO or indium tin oxide (In₂O₃)_{0.9}(SnO₂)_{0.1}, diamond (C), aluminum nitride (AlN) and mixtures thereof.

59. The device of claim 58, wherein the photoanode is activated by one or more of sun light, visible-light, ultra-violet light or a mixture thereof.

60. The device of claim 58, further comprising:
contacting electromagnetic energy with the photoanode by one or both concentrating and channeling electromagnetic energy devices.

61. The device of claim 60, wherein the concentrating device comprises one or more lenses.

62. The device of claim 60, wherein the channeling device comprises one or more optical fibers.

63. The device of claim 46, wherein the anode generates an electric current by oxidizing cerium (+3) to cerium (+4).

64. The device of claim 46, further comprising:
a porous wall positioned between the anodic and catalyst compartments, the porous wall is permeable to cerium (+3) and cerium (+4).

65. The device of claim 64, wherein the porous wall comprises one or both of a macro-porous wall and a micro-porous wall.

66. The device of claim 46, wherein the photoanode has a bandgap of at least about 1.2 eV whereby when the photoanode is irradiated with electromagnetic energy, the device generates sufficient electrochemical potential to carry out an electrolysis process with little, if any, electrical power from an applied power source.

67. The device of claim 46, wherein the photoanode has a bandgap of less than about 1.2 eV, whereby when the photoanode is irradiated with electromagnetic energy, the device requires application of at least some additional electrical energy from the power source to carry out an electrochemical process.
